(19) United States
(12) Patent Application Publication
(10) Pub. No.: US 2025/0054949 A1
(43) Pub. Date: Feb. 13, 2025

(54) ONE-BODY PARTICLE AND ACTIVE MATERIAL FOR SECONDARY BATTERY INCLUDING SAME

(71) Applicant: L&F CO., LTD., Daegu (KR)

(72) Inventors: Han Ah KIM, Daegu (KR); Gi Hwan CHANG, Daegu (KR); Hyun Gyu HAN, Daegu (KR); Hwa Young SON, Daegu (KR); Jae Joon JO, Daegu (KR); Seul Gi JEON, Daegu (KR); Sung Kyun CHANG, Daegu (KR); Doe Hyoung KIM, Daegu (KR)

(21) Appl. No.: 18/720,052

(22) PCT Filed: Jan. 20, 2023
(86) PCT No.: PCT/KR2023/001000

§ 371 Date: Jun. 14, 2024

(30) Foreign Application Priority Data
Jan. 27, 2022 (KR) 10-2022-0012242

(51) Int. Cl. H01M 4/36; H01M 4/02; H01M 4/505; H01M 4/525; H01M 10/052

(52) U.S. Cl. CPC H01M 4/366; H01M 4/505; H01M 4/525; H01M 10/052; H01M 2004/028

(57) ABSTRACT

Disclosed is a one-body particle including a core present as a non-aggregated primary particle and a coating layer formed on at least a part of the core, wherein the coating layer is a multilayer coating layer containing at least one of a +3 or +4 element, and an active material for secondary batteries including the same.

### TECHNICAL FIELD

The present invention relates to a novel one-body particle capable of providing secondary batteries with excellent overall characteristics and an active material for secondary batteries including the same.

### BACKGROUND ART

Lithium secondary batteries are used in various fields such as mobile devices, energy storage systems, and electric vehicles due to advantages including high energy density and voltage, long cycle lifespan, and low self-discharge rate.

The cathode active material particle used in a lithium secondary battery generally has a secondary particle structure having a size of several m in which fine primary particles having a sub-micron size are aggregated. Such a secondary particle structure has a problem in that the secondary particle is broken as the aggregated primary particles are separated during repeated charging and discharging, causing deterioration in battery characteristics. Since this problem is due to the structural characteristics of the secondary particle, it is difficult to solve the problem without changing the structure thereof. Therefore, a one-body particle cathode active material having a novel structure has been developed.

This one-body particle active material has a “non-aggregated single particle (primary particle)” structure rather than a conventional “secondary particle structure including aggregated primary particles” and undergoes no particle separation during charging and discharging, and thus solves problems occurring in secondary particle active materials because there is almost no particle aggregation.

Here, the expression “there is almost no particle aggregation” means that a small amount of aggregate is inevitably present during the preparation of one-body particles/powders. That is, it is impossible for all particles to be completely separated from one another due to technical limitations, so some aggregate may be unintentionally formed. The proportion of some aggregated particles may be within 30% of the total active material powder. Such some aggregated particles are not conventional secondary particles.

In addition, the term “active material” encompasses both “particle” and “powder” including a plurality of particles. In the art, both particles and powders are commonly called “active materials”. It is common to distinguish whether the term refers to particles or powder depending on the context in which it is used, but in the present invention, “particles” and “active material (powder)” are expressed separately to avoid confusion.

Unlike conventional secondary particles, the one-body particle has a size of several m and does not have an aggregate structure, thus causing no particle separation during charging and discharging, and fundamentally solving problems occurring in secondary particle structures.

However, the secondary particle active material has been commercialized for a long time and has been applied to various industrial fields, but the one-body particle active material is still used only for research purposes because it is very difficult to secure stability thereof.

This is due to differences in calcination temperature and structure therebetween. As described above, the reason for this is that problems of the secondary particle active material that are difficult to solve can be easily avoided by the one-body particle, whereas problems that do not need to be considered in the secondary particle active material are critical in the one-body particle, and are very difficult to solve. In particular, practical application of one-body particle active materials is highly difficult due to difficulty in securing stable properties due to the high calcination temperature. As the Ni content increases to 70% (high-Ni) or more, structural instability increases rapidly, leading to deterioration of properties.

Therefore, there is an increasing need for new technologies that can solve these problems.

### DISCLOSURE

### Technical Problem

Therefore, the present invention has been made to solve the above and other technical problems that have yet to be solved.

Therefore, as a result of extensive research and various experiments, the present inventors prepared a novel one-body particle and found that the secondary battery manufactured using such one-body particle had excellent overall characteristics. Based on this finding, the present invention was completed.

### Technical Solution

In accordance with an aspect of the present invention, provided is a novel one-body particle including a core present as a non-aggregated primary particle and a coating layer formed on at least a part of the core, wherein the coating layer is a multilayer containing at least one of a +3 or +4 element.

The coating layer includes, for example, an internal coating layer containing at least one of Ni, Co, or Mn and at least one of Zr, Ti, Al, W, B, P, Mg, Cr, V, or Y, and formed in an inward direction from a core surface and an external coating layer containing at least one of Zr, Ti, Al, W, B, P, Mg, Cr, V, or Y, and formed in an outward direction from the core surface.

In a specific embodiment, the core may contain a composition of Formula 1 below, the internal coating layer may contain a composition of Formula 2 below, and the external coating layer may contain a composition of Formula 3 below. This configuration can be seen from FIG. 1.

LiₐNi_{b}Co_{c}Mn_{d}DₑOₓ (1)
wherein a, b, c, d, e and x satisfy 0.95≤a≤1.1, 0<b≤1, 0≤c<1, 0≤d<1, 0≤e≤0.05, and 0<x≤4, respectively, and
D is a doping element and includes at least one of Ti, Zr, Al, P, Si, B, W, Mg, Sn, or Y,

Li_{f}Ni_{g}CoₕMnᵢM1ⱼM2ₖO_{y} (2)
wherein f, g, h, i, j, k and y satisfy 0.95≤f≤1.1, 0≤g<1, 0<h<1, 0≤i<1, 0<j<1, 0<k<1, and 0<y≤8, respectively, and
M1 and M2 independently include at least one of Zr, Ti, Al, W, B, P, Mn, Ni, Mg, Cr, V, or Y, and are different from each other,

LiₗM3ₘM4ₙO_{z} (3)
wherein l, m, n and z satisfy 0≤l≤1.1, 0<m<1, 0<n<1, and 0<z≤8, respectively, and
M3 and M4 independently include at least one of Zr, Ti, Al, W, B, P, Mn, Ni, Mg, Cr, V, or Y, and are different from each other.

More specifically, the internal coating layer may contain a composition of Formula 2 below and the external coating layer may contain a composition of Formula 3 below:

Li_{f}Ni_{g}CoₕMnᵢM1ⱼM2ₖO_{y} (2)
wherein
f, g, h, i, j, k and y satisfy 0.95≤f≤1.1, 0≤g<1, 0<h<1, 0≤i<1, 0<j<1, 0<k<1, and 0<y≤8, respectively;
M1 is Al; and
M2 includes at least one of Zr or Ti,

LiₗM3ₘM4ₙO_{z} (3)
wherein
l, m, n and z satisfy 0≤l≤1.1, 0<m<1, 0<n<1, and 0<z≤8, respectively,
M3 is Al; and
M4 includes at least one of Zr or Ti.

As can be seen from Table 1 of the experiment described later, excellent properties are obtained when 30%<M1<100% and 0%<M3<70% based on a total of M1 and M3 of 100% are satisfied, and 0%<M2<30% and 70%<M4<100% based on a total of M2 and M4 of 100% are satisfied. More preferably, optimum properties are obtained when 70%≤M1≤90% and 10%≤M3≤30% based on a total of M1 and M3 of 100% are satisfied, and 10%≤M2≤30% and 70%≤M4≤90% based on a total of M2 and M4 of 100% are satisfied.

The internal coating layers and the external coating layer simultaneously contain at least one element and the corresponding element may have a concentration gradient.

In another specific embodiment, the one-body particle according to the present invention includes an internal coating layer containing a composition of Formula 2 below and external coating layers containing a composition of Formula 3 and a composition of Formula 4 below. An example of this configuration can be seen from FIG. 2.

Li_{f}Ni_{g}CoₕMnᵢM1ⱼM2ₖO_{y} (2)
wherein f, g, h, i, j, k and y satisfy 0.95≤f≤1.1, 0≤g<1, 0<h<1, 0≤i<1, 0<j<1, 0<k<1, and 0<y≤8, respectively, and
M1 and M2 independently include at least one of Zr, Ti, Al, W, B, P, Mn, Ni, Mg, Cr, V, or Y, and are different from each other,

LiₗM3ₘM4ₙM5ₒO_{z} (3)
wherein l, m, n, o and z satisfy 0≤l≤1.1, 0<m<1, 0<n<1, 0<o<1, and 0<z≤8, respectively, and
M3, M4, and M5 independently include at least one of Zr, Ti, Al, W, B, P, Mn, Ni, Mg, Cr, V, or Y, and are different from each other.

LiₚM6_{q}M7ᵣOᵥ (4)
wherein
p, q, r and v satisfy 0≤p≤1.1, 0<q<1, 0<r<1, and 0<v≤8, respectively; and
M6 and M7 independently include at least one of Zr, Ti, Al, W, B, P, Mn, Ni, Mg, Cr, V, or Y, and are different from each other.

More specifically, Formulas 2 to 4 may be represented as follows:

Li_{f}Ni_{g}CoₕMnᵢM1ⱼM2ₖO_{y} (2)
wherein
f, g, h, i, j, k and y satisfy 0.95≤f≤1.1, 0≤g<1, 0<h<1, 0≤i<1, 0<j<1, 0<k<1, and 0<y≤8, respectively;
M1 is Al; and
M2 includes at least one of Zr or Ti,

LiₗM3ₘM4ₙM5ₒO_{z} (3)
wherein
l, m, n, o, and z satisfy 0≤l≤1.1, 0<m<1, 0<n<1, 0<o<1, and 0<z≤8, respectively,
M3 is Al;
M4 includes at least one of Zr or Ti; and
M5 is B,

LiₚM6_{q}M7ᵣOᵥ (4)
wherein
p, q, r and v satisfy 0≤p≤1.1, 0<q<1, 0<r<1, and 0<v≤8, respectively;
M6 includes at least one of Zr or Ti; and
M7 is B.

Excellent properties are obtained when 30%<M1<100% and 0%<M3<70% based on a total of M1 and M3 of 100% are satisfied, 0%<M2<30%, 70%<M4<100%, and 0%<M6<30% based on a total of M2, M4, and M6 of 100% are satisfied, and 0%<M5<40% and 60%<M7<100% based on a total of M5 and M7 of 100% are satisfied.

The internal coating layer and the external coating layer may be added entirely or locally on the core and may be added in any one of various forms that can achieve the desired effect of the present invention. In one specific example, at least one of the internal coating layer or the external coating layer may be in the form of an island, an example of which can be seen from Experimental Example 3 described later.

The present invention also provides an active material for secondary batteries including the novel one-body particle.

The active material for secondary batteries according to the present invention includes an aggregate including a plurality of one-body particles, or a mixture of non-aggregated one-body particles and the aggregate, and includes a coating layer formed in at least one area of grain boundaries where the surfaces of the one-body particles constituting the aggregate come into contact with each other, pores or gaps between the one-body particles, and the surfaces of the one-body particles, and the coating layer is formed as multiple layers containing at least one of a +3 or +4 element.

In conventional coating layer-related technologies, a coating layer is formed only on the outermost surface of aggregated particles. However, when the aggregate is broken by external force, the surface of the particles is exposed to the outside, thus causing various problems such as great deterioration in the effectiveness of the coating layer and reduced electrical properties and side reactions, and making it difficult to maintain the effects of the coating layer.

On the other hand, when a coating layer is formed between the one-body particles constituting the aggregate as in the present invention, even if the aggregate is broken by external force, the coating layer is formed on the surface of each one body particle and the surface of the one body particle is not directly exposed to the outside. As a result, the problems described above can be avoided.

The coating layer, for example, includes an internal coating layer containing at least one of Ni, Co, or Mn, and at least one of Zr, Ti, Al, W, B, P, Mg, Cr, V, or Y and formed in an inward direction from a core surface and an external coating layer containing at least one of Zr, Ti, Al, W, B, P, Mg, Cr, V, or Y and formed in an outward direction from the core surface.

Other details of the coating layer may be the same as described above with reference to the one-body particles.

The configuration and production method of the active material for secondary batteries are known in the art, and thus a detailed description thereof will be omitted herein.

### Effects of the Invention

As described above, the one-body particle according to the present invention has distinguishing effects of improving resistance, capacity, efficiency, residual lithium, lifespan and resistance increase rate characteristics of secondary batteries manufactured using the one-body particle.

### DESCRIPTION OF THE DRAWINGS

FIGS. 1 and 2 are schematic diagrams illustrating the configuration of coating layers including an internal coating layer and an external coating layer(s) according to an example of the present invention;

FIGS. 3A to 3E are EDS images of the FE-TEM cross-section of cathode active material particles of Comparative Example 3, wherein (a) is an FE-TEM cross-section image, (b) is a Ni element image, (c) is an Ni element image wherein a core boundary is marked, (d) is an Al element image, and (e) is a Zr element image;

FIGS. 4A to 4E are EDS images of the FE-TEM cross-section of cathode active material particles of Example 3, wherein (a) is an FE-TEM cross-section image, (b) is a Ni element image, (c) is a Ni element image wherein a core boundary is marked, (d) is an Al element image, and (e) is a Zr element image;

FIGS. 5A to 5E are EDS images of the FE-TEM cross-section of cathode active material particles of Example 4, wherein (a) is an FE-TEM cross-section image, (b) is a Ni element image, (c) is a Ni element image wherein a core boundary is marked, (d) is an Al element image, and (e) is a Zr element image;

FIGS. 6A to 6B are graphs of XPS analysis performed in Experimental Example 4, where (1) is the result of Comparative Example 3 and (2) is the result of Example 3; and

FIG. 7 is a graph showing a nanoSIMS analysis performed in Experimental Example 5, where section (a) is a baseline indicating the surface boundary of the particle.

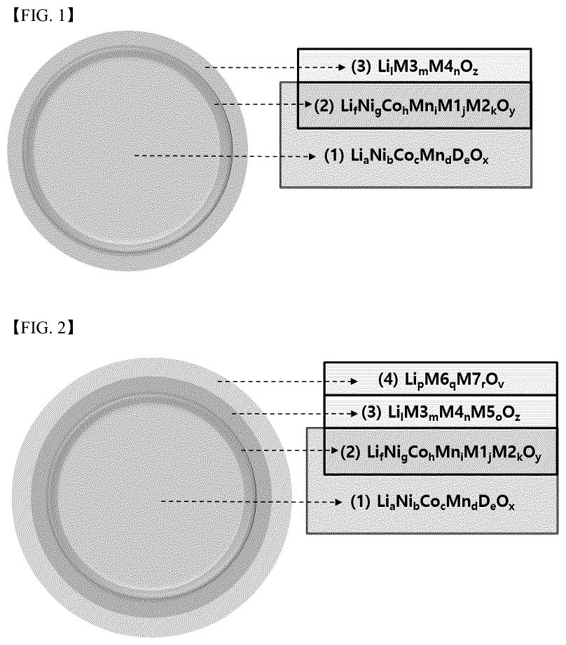

### BEST MODE

Now, the present invention will be described in more detail with reference to the following examples. These examples should not be construed as limiting the scope of the present invention.

### Preparation Example 1

NiSO₄ as a nickel raw material, CoSO₄ as a cobalt raw material, and MnSO₄ as a manganese raw material were added at a molar ratio of 75:15:10 to distilled water in a 6,000 L cylindrical reactor to prepare an aqueous solution. A predetermined amount of the aqueous solution was added dropwise thereto at a rate of 20 mL/min and an aqueous ammonia solution was added dropwise thereto at a rate of 10 mL/min while stirring at 320 rpm in the reactor. At this time, the pH in the reactor was adjusted to 11 to 12, the ammonia concentration in the reactor was adjusted to 3,000 to 6,000 ppm and the reaction mixture was stirred for 10 hours while maintaining the temperature of the reactor at 50 to 60° C. The precipitate during the process was filtered and dried at 100 to 120° C. for 12 hours to prepare a cathode active material precursor of (Ni_{0.75}Co_{0.15}Mn_{0.10})(OH)₂. At this time, the average particle diameter (D50) of the prepared precursor was 3 to 6 μm.

### Preparation Example 2

A cathode active material precursor with a ratio of Ni, Co, and Mn compounds in the aqueous solution of 88:04:08 was prepared in the same manner as in Preparation Example 1.

### Preparation Example 3

A cathode active material precursor with a ratio of Ni, Co, and Mn compounds in the aqueous solution of 93:05:02 was prepared in the same manner as in Preparation Example 1.

### Preparation Example 4

A cathode active material precursor with a ratio of Ni, Co, and Mn compounds in the aqueous solution of 98:00:02 (i.e., the Co compound was not added) was prepared in the same manner as in Preparation Example 1.

### Comparative Example 1

The cathode active material precursor prepared in Preparation Example 1 and LiOH—H₂O (SQM) were measured at a ratio of Li/Metal=1.01, and 2,000 ppm of ZrO₂ and 2,000 ppm of Al(OH)₃ were further weighed to prepare for mixing. The weighed substances were injected into a 10 L Henschel mixer and stirred at 3,000 rpm for 30 mins to prepare a mixture. The mixture was charged into RHK (roller heated kiln) and calcined at a temperature of 930° C. for 20 hours while maintaining an oxygen atmosphere, and then cooled to room temperature. Then, the obtained calcined material was pulverized using a grinder ACM to prepare a cathode active material with a D50 of 3 to 6 μm.

### Comparative Example 2

A cathode active material was prepared in the same manner as in Comparative Example 1 using the cathode active material precursor prepared in Preparation Example 2, except that the calcination temperature was 910° C.

### Comparative Example 3

A cathode active material was prepared in the same manner as in Comparative Example 1 using the cathode active material precursor prepared in Preparation Example 3, except that the calcination temperature was 890° C.

### Comparative Example 4

A cathode active material was prepared in the same manner as in Comparative Example 1 using the cathode active material precursor prepared in Preparation Example 4, except that the calcination temperature was 900° C.

### Comparative Example 5

The primarily calcined cathode active material of Comparative Example 3 was mixed with 3,000 ppm of an Al(OH)₃ additive using a 2 L powder mixer (Youwan tech) at an internal impeller speed of 3,000 rpm and at a mixing zone rotation speed of 10 rpm for 10 minutes and then the resulting mixture was allowed to stand for 1 minute.

This process was repeated three times to complete mixing. Then, the mixture was calcined at 700° C. for 13 hours to prepare an active material with an Al internal coating layer.

### Comparative Example 6

The primarily calcined cathode active material of Comparative Example 3 was mixed with 2,000 ppm of an ZrO₂ additive using a 2 L powder mixer (Youwan tech) at an internal impeller speed of 3,000 rpm and at a mixing zone rotation speed of 10 rpm for 10 minutes and then the resulting mixture was allowed to stand for 1 minute. This process was repeated three times to complete mixing. Then, the mixture was calcined at 700° C. for 13 hours to prepare an active material with a Zr external coating layer.

### Comparative Example 7

The primarily calcined cathode active material of Comparative Example 3 was mixed with 1,000 ppm of a TiO₂ additive using a 2 L powder mixer (Youwan tech) at an internal impeller speed of 3,000 rpm and at a mixing zone rotation speed of 10 rpm for 10 minutes and then then the resulting mixture was allowed to stand for 1 minute. This process was repeated three times to complete mixing. Then, the mixture was calcined at 700° C. for 13 hours to prepare an active material with a Ti external coating layer.

### Comparative Example 8

The primarily calcined cathode active material of Comparative Example 2 was mixed with 2,000 ppm of an WO₃ additive using a 2 L powder mixer (Youwan tech) at an internal impeller speed of 3,000 rpm and at a mixing zone rotation speed of 10 rpm for 10 minutes and then the resulting mixture was allowed to stand for 1 minute. This process was repeated three times to complete mixing. Then, the mixture was calcined at 400° C. for 7 hours to prepare an active material with a W external coating layer.

### Example 1

The primarily calcined cathode active material of Comparative Example 1 was mixed with 3,000 ppm of an Al(OH)₃ additive and 2,000 ppm of an ZrO₂ additive using a 2 L powder mixer (Youwan tech) at an internal impeller speed of 3,000 rpm and at a mixing zone rotation speed of 10 rpm for 10 minutes and then then the resulting mixture was allowed to stand for 1 minute. This process was repeated three times to complete mixing. Then, the mixture was calcined at 700° C. for 13 hours to prepare an active material with Al and Zr internal and external coating layers.

### Example 2

The primarily calcined cathode active material of Comparative Example 2 was mixed with 3,000 ppm of an Al(OH)₃ additive and 2,000 ppm of an ZrO₂ additive using a 2 L powder mixer (Youwan tech) at an internal impeller speed of 3,000 rpm and at a mixing zone rotation speed of 10 rpm for 10 minutes and then then the resulting mixture was allowed to stand for 1 minute. This process was repeated three times to complete mixing. Then, the mixture was calcined at 700° C. for 13 hours to prepare an active material with Al and Zr internal and external coating layers.

### Example 3

The primarily calcined cathode active material of Comparative Example 3 was mixed with 3,000 ppm of an Al(OH)₃ additive and 2,000 ppm of an ZrO₂ additive using a 2 L powder mixer (Youwan tech) at an internal impeller speed of 3,000 rpm and at a mixing zone rotation speed of 10 rpm for 10 minutes and then then the resulting mixture was allowed to stand for 1 minute. This process was repeated three times to complete mixing. Then, the mixture was calcined at 700° C. for 13 hours to prepare an active material with Al and Zr internal and external coating layers.

### Example 4

The primarily calcined cathode active material of Comparative Example 3 was mixed with 3,000 ppm of an Al(OH)₃ additive and 2,000 ppm of an ZrO₂ additive using a 2 L powder mixer (Youwan tech) at an internal impeller speed of 3,000 rpm and at a mixing zone rotation speed of 10 rpm for 10 minutes and then the resulting mixture was allowed to stand for 1 minute. This process was repeated three times to complete mixing. Then, the mixture was calcined at 500° C. for 13 hours to prepare an active material with Al and Zr internal and external coating layers, wherein the external coating layer was relatively thick.

### Example 5

The primarily calcined cathode active material of Comparative Example 4 was mixed with 3,000 ppm of an Al(OH)₃ additive and 2,000 ppm of an ZrO₂ additive using a 2 L powder mixer (Youwan tech) at an internal impeller speed of 3,000 rpm and at a mixing zone rotation speed of 10 rpm for 10 minutes and then the resulting mixture was allowed to stand for 1 minute. This process was repeated three times to complete mixing. Then, the mixture was calcined at 700° C. for 13 hours to prepare an active material with Al and Zr internal and external coating layers.

### Example 6

The primarily calcined cathode active material of Comparative Example 3 was mixed with 3,000 ppm of an Al(OH)₃ additive and 1,000 ppm of a TiO₂ additive using a 2 L powder mixer (Youwan tech) at an internal impeller speed of 3,000 rpm and at a mixing zone rotation speed of 10 rpm for 10 minutes and then the resulting mixture was allowed to stand for 1 minute. This process was repeated three times to complete mixing. Then, the mixture was calcined at 700° C. for 13 hours to prepare an active material with Al and Zr internal and external coating layers.

### Example 7

The primarily calcined cathode active material of Comparative Example 3 was mixed with 3,000 ppm of an Al(OH)₃ additive and 1,000 ppm of a TiO₂ additive using a 2 L powder mixer (Youwan tech) at an internal impeller speed of 3,000 rpm and at a mixing zone rotation speed of 10 rpm for 10 minutes and then the resulting mixture was allowed to stand for 1 minute. This process was repeated three times to complete mixing. Then, the mixture was calcined at 500° C. for 13 hours to prepare an active material with Al and Zr internal and external coating layers, wherein the external coating layer was relatively thick.

### Example 8

The primarily calcined cathode active material of Comparative Example 3 was mixed with 3,000 ppm of an Al(OH)₃ additive and 2,000 ppm of a ZrO₂ additive using a 2 L powder mixer (Youwan tech) at an internal impeller speed of 3,000 rpm and at a mixing zone rotation speed of 10 rpm for 10 minutes and then then the resulting mixture was allowed to stand for 1 minute. This process was repeated three times to complete mixing. Then, the mixture was calcined at 700° C. for 13 hours and then was mixed with 1,000 ppm of a B₂O₃ additive using a 2 L powder mixer (Youwan tech) at an internal impeller speed of 1,500 rpm and at a mixing zone rotation speed of 10 rpm for 10 minutes and then the resulting mixture was allowed to stand for 1 minute. This process was repeated three times to complete mixing. Then, the resulting mixture was calcined at 400° C. for 7 hours.

### Example 9

The primarily calcined cathode active material of Comparative Example 2 was mixed with 3,000 ppm of an Al(OH)₃ additive using a 2 L powder mixer (Youwan tech) at an internal impeller speed of 3,000 rpm and at a mixing zone rotation speed of 10 rpm for 10 minutes and then the resulting mixture was allowed to stand for 1 minute. This process was repeated three times to complete mixing. Then, the mixture was calcined at 700° C. for 13 hours and then was mixed with 2,000 ppm of a WO₃ additive using a 2 L powder mixer at an internal impeller speed of 3,000 rpm and at a mixing zone rotation speed of 10 rpm for 10 minutes and then the resulting mixture was allowed to stand for 1 minute. This process was repeated three times to complete mixing. Then, the resulting mixture was calcined at 400° C. for 7 hours.

### [Experimental Example 1]—Measurement of Resistance

The cation active material synthesized in each of Comparative Examples 1 to 8, and Examples 1 to 9, Super-P as a conductive material, and PVdF as a binder were mixed at a weight ratio of 96:2:2 in the presence of N-methylpyrrolidone as a solvent to prepare a cathode active material slurry. The cathode active material slurry was applied onto an aluminum current collector, dried at 120° C., and then rolled to produce a cathode.

A porous polyethylene film as a separator was interposed between the cathode produced as described above and a Li metal anode to produce an electrode assembly, the electrode assembly was placed in a battery case, and an electrolyte was injected into the battery case to produce a lithium secondary battery. The electrolyte used herein was prepared by dissolving 1.0M lithium hexafluorophosphate (LiPF₆) in an organic solvent consisting of ethylene carbonate/dimethyl carbonate (mixed at a volume ratio of EC/DMC=1/1).

### (1) Measurement of Resistance

Each of the lithium secondary batteries thus produced was subjected to charge (at 0.2C, 4.25V) and discharge (at 0.2C, 2.5V). A voltage change for 0 to 65 seconds from the start of discharge was divided by the applied current to calculate resistance (V/I=R). The results are shown in Table 1 below.

### (2) Measurement of Lifespan and Resistance Increase Rate

The lifespan and resistance increase rate of each of the lithium secondary batteries produced above were repeatedly measured 50 times at 45° C. under the conditions of 0.5C, 4.25V (charge) and 1.0C, 2.5V (discharge). The results are shown in Table 1 below.

### [Experimental Example 2]—Measurement of Residual Lithium

Residual lithium was measured under the following conditions in the cathode active materials prepared in Comparative Examples 1 to 8 and Examples 1 to 9, and the results are shown in Table 1 below.

### \textcircled{1} Sample Pretreatment

5±0.01 g of sample and 100 g of distilled water were added to a conical beaker containing a magnetic bar, followed by stirring for 5 minutes.
The stirred sample was naturally filtered through filter paper.
The filtrate was titrated in a beaker.

### \textcircled{2} Test Method

A titrator was filled with a titrant (0.1N HCl), and then bubbles were removed from the cylinder.
Titrant: 0.1N HCl
Titrant aliquot method: DET
Condition for automatic completion of titration: pH 2.5
Calculation: FP(1)=4.5, EP(1)
Titration rate: Greatest.

As can be seen from Table 1 below, the secondary batteries of Examples according to the present invention exhibit overall superior resistance, capacity, efficiency, residual lithium, lifespan, and resistance increase rate characteristics compared to the secondary batteries of Comparative Examples. In particular, in order to secure excellent properties, the prior art often uses Co as the main coating element, whereas the present invention exhibits excellent effects even though it does not contain Co, which is a very expensive raw material.

TABLE 1

| | | | | Charge | Discharge | | Residual | | Resistance |
|---|---|---|---|---|---|---|---|---|---|
| | Internal | External | Resistance | capacity | capacity | Efficiency | lithium | Lifespan | increase |
| | content | content | (Ohm) | (mAh/g) | (mAh/g) | (%) | (%) | (%) | (%) |
| Comparative | — | — | 17.1 | 220.4 | 193.8 | 87.9 | 0.325 | 90.7 | 122.1 |
| Example 1 | | | | | | | | | |
| Comparative | — | — | 17.9 | 230.7 | 202.6 | 87.8 | 0.436 | 90.4 | 112.7 |
| Example 2 | | | | | | | | | |
| Comparative | — | — | 24.9 | 245.1 | 211.7 | 86.4 | 0.738 | 89.5 | 70.0 |
| Example 3 | | | | | | | | | |
| Comparative | — | — | 32.8 | 245.9 | 208.1 | 84.6 | 0.808 | 86.9 | 67.8 |
| Example 4 | | | | | | | | | |
| Comparative | Al 80- | Al 10- | 25.1 | 243.7 | 211.5 | 86.8 | 0.677 | 91.8 | 65.0 |
| Example 5 | 90% | 20% | | | | | | | |
| Comparative | Zr 10- | Zr 80- | 23.1 | 245.8 | 211.6 | 86.1 | 0.682 | 91.2 | 77.4 |
| Example 6 | 20% | 90% | | | | | | | |
| Comparative | Ti 20- | Ti 70- | 22.7 | 243.6 | 209.3 | 85.9 | 0.598 | 91.3 | 70.9 |
| Example 7 | 30% | 80% | | | | | | | |
| Comparative | W 10- | W 80- | 17.9 | 231.2 | 203.5 | 88.0 | 0.402 | 91.1 | 98.6 |
| Example 8 | 20% | 90% | | | | | | | |
| Example 1 | Al 80- | Al 10- | 15.9 | 222.3 | 198.1 | 89.1 | 0.243 | 95.6 | 90.4 |
| | 90% | 20% | | | | | | | |
| | Zr 10- | Zr 80- | | | | | | | |
| | 20% | 90% | | | | | | | |
| Example 2 | Al 80- | Al 10- | 16.3 | 231.7 | 206.2 | 89.0 | 0.367 | 93.8 | 80.2 |
| | 90% | 20% | | | | | | | |
| | Zr 10- | Zr 80- | | | | | | | |
| | 20% | 90% | | | | | | | |
| Example 3 | Al 80- | Al 10- | 23.4 | 246.2 | 214.4 | 87.1 | 0.662 | 93.4 | 67.0 |
| | 90% | 20% | | | | | | | |
| | Zr 10- | Zr 80- | | | | | | | |
| | 20% | 90% | | | | | | | |
| Example 4 | Al 30- | Al 60- | 25.0 | 245.1 | 212.3 | 86.6 | 0.709 | 92.1 | 71.0 |
| | 40% | 70% | | | | | | | |
| | Zr 10- | Zr 80- | | | | | | | |
| | 20% | 90% | | | | | | | |
| Example 5 | Al 80- | Al 10- | 30.2 | 248.3 | 212.5 | 85.6 | 0.764 | 91.8 | 40.8 |
| | 90% | 20% | | | | | | | |
| | Zr 10- | Zr 80- | | | | | | | |
| | 20% | 90% | | | | | | | |
| Example 6 | Al 70- | Al 20- | 23.2 | 245.1 | 212.7 | 86.8 | 0.563 | 93.6 | 55.8 |
| | 80% | 30% | | | | | | | |
| | Ti 20- | Ti 70- | | | | | | | |
| | 30% | 80% | | | | | | | |
| Example 7 | Al 30- | Al 60- | 25.3 | 244.6 | 211.1 | 86.3 | 0.688 | 92.7 | 62.0 |
| | 40% | 70% | | | | | | | |
| | Ti 20- | Ti 70- | | | | | | | |
| | 30% | 80% | | | | | | | |
| Example 8 | Al 80- | Al 10- | 30.5 | 247.5 | 216.3 | 87.4 | 0.608 | 92.5 | 49.7 |
| | 90% | 20% | | | | | | | |
| | Zr 10- | Zr 80- | | | | | | | |
| | 20% | 90% | | | | | | | |
| | B 0- | B 90- | | | | | | | |
| | 10% | 100% | | | | | | | |
| Example 9 | Al 80- | Al 10- | 17.1 | 231.9 | 207.1 | 89.3 | 0.388 | 92.8 | 88.3 |
| | 90% | 20% | | | | | | | |
| | W 10- | W 80- | | | | | | | |
| | 20% | 90% | | | | | | | |

### [Experimental Example 3]—FE-TEM Analysis

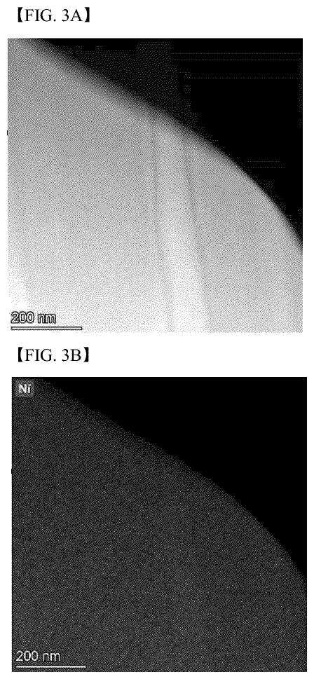

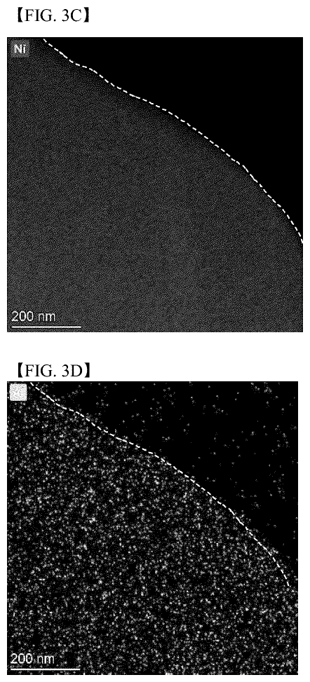

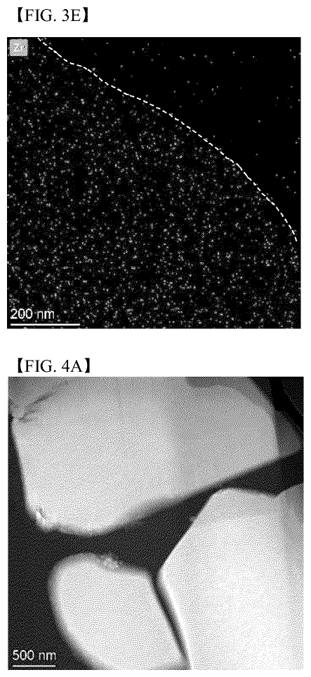

For FE-SEM analysis of the cathode active materials prepared in Comparative Example 3, Example 3 and Example 4, the cathode active materials were faced using a focused ion beam (FIB) and FE-TEM was performed under the following analysis conditions. The results are shown in FIGS. 3A to 3E, FIGS. 4A to 4E, and FIGS. 5A to 5E.

### [FE-SEM Measurement Conditions]

Electron Gun type: High brightness Schottky FEG (X-FEG)
Acceleration voltage: 80 to 200 kV
Cs correction: Probe Cs-corrector
TEM resolution: 0.24 nm
Information limit with probe Cs: 0.11 nm
STEM resolution with probe Cs: 0.08 nm
EDS: 4 SDDs windowless (Super-X)

FIGS. 3A to 3E are EDS images of the FE-TEM cross-section of cathode active material particles of Comparative Example 3, wherein (a) is an FE-TEM cross-section image, (b) is a Ni element image, (c) is an Ni element image wherein a core boundary is marked, (d) is an Al element image, and (e) is a Zr element image.

It can be seen from FIGS. 3A to 3E that the Al and Zr elements are doped inside the particles and uniformly distributed inside the particles. In terms of doping content, a dark EDS image can be seen because Al has a relatively higher content than Zr. Al and Zr elements uniformly distributed therein can be seen from Examples 3 and 4.

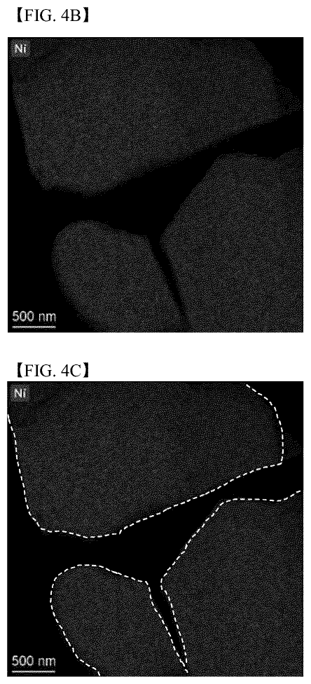

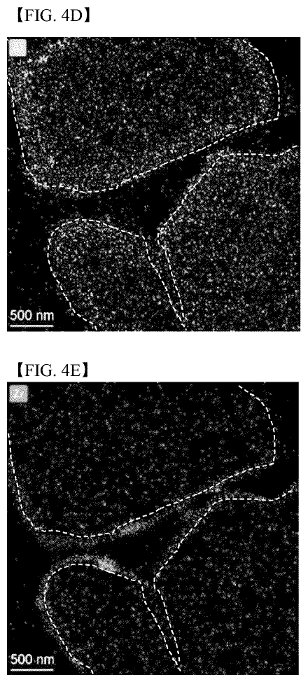

FIGS. 4A to 4E are EDS images of the FE-TEM cross-section of cathode active material particles of Example 3, wherein (a) is an FE-TEM cross-section image, (b) is a Ni element image, (c) is a Ni element image wherein a core boundary is marked, (d) is an Al element image, and (e) is a Zr element image. The positions of the Al and Zr elements compared to the positions of the Ni elements can be seen from these drawings. It can be seen that the Al element is located relatively inward, while the Zr element is located relatively outward. In addition, these images show a coating layer formed in the pores of the one-body particles.

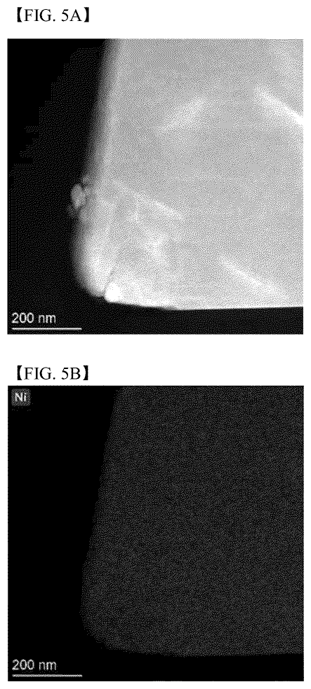

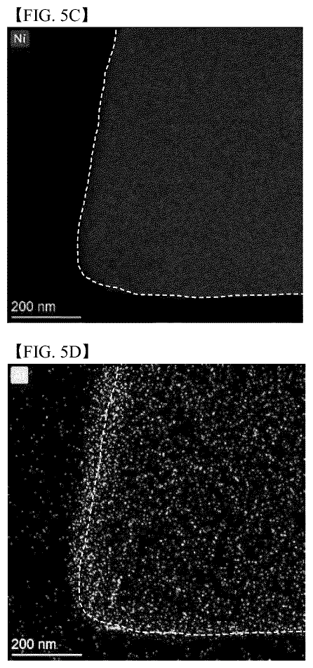

FIGS. 5A to 5E are EDS images of the FE-TEM cross-section of cathode active material particles of Example 4, wherein (a) is an FE-TEM cross-section image, (b) is a Ni element image, (c) is a Ni element image wherein a core boundary is marked, (d) is an Al element image, and (e) is a Zr element image. The positions of the Al and Zr elements compared to the positions of the Ni elements can be seen from these drawings. Compared to the results of Example 3, the Zr element may constitute an island-shaped spot coating layer. The Zr element may also constitute an island coating layer as in Example 4.

### [Experimental Example 4]—XPS Analysis

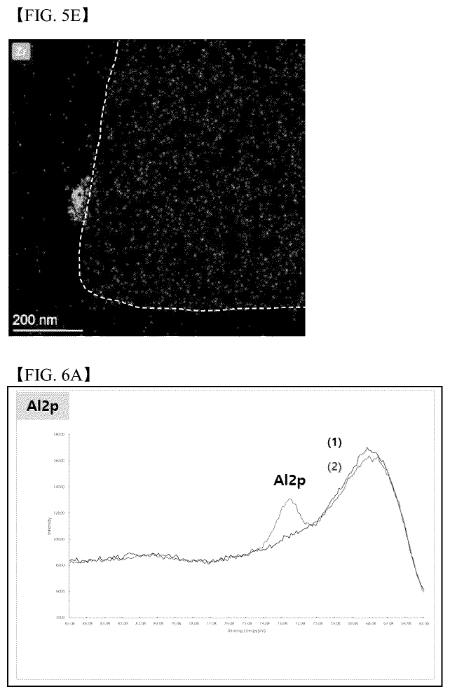

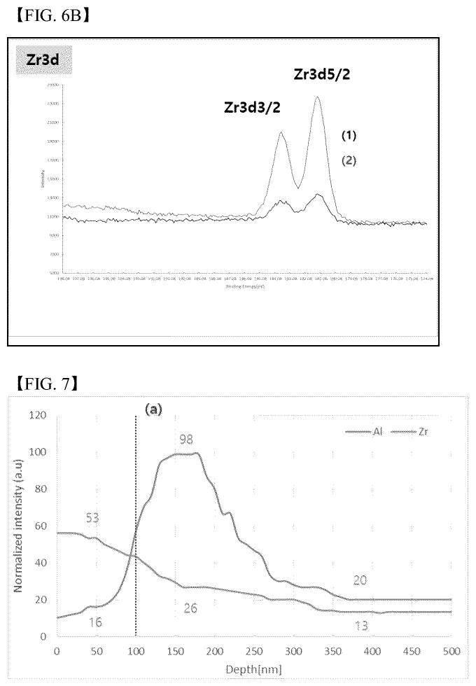

XPS analysis of the cathode active materials prepared in Comparative Example 3 and Example 3 was performed to analyze the surface of the particles at a depth of 10 nm from the inside of the particles and the results are shown in FIGS. 6A and 6B. The measurement equipment specifications for XPS analysis are as follows.

### [Measurement Equipment Specifications]

Microfocus monochromatic X-ray source: Al-Kα (1486.6 eV)
X-ray spot size: 10-400 μm
Energy resolution (Ag 3d5/2): ≤0.5 eV
Sensitivity: 4,000,000 cps (400 μm)
Ultimate vacuum: <5×10-9 mbar
Depth profile: Ion gun Ar monatomic/Cluster source
UV Photoelectron Spectroscopy (UPS)
Ion Scattering Spectroscopy (ISS)
Reflected Energy Electron Loss Spectroscopy (REELS)
Angle Resolved XPS (ARXPS)
Vacuum transfer holder: Maximum specimen thickness 9 mm

As can be seen from FIGS. 6A and 6B, the Al2p peak is observed at the binding energy of about 73.08 eV, and Zr3d peaks are observed, more specifically, the Zr3d5/2 peak is observed at the binding energy of 181.3 eV, and the Zr3d3/2 peak is observed at the binding energy of 183.6 eV. From these results, it can be seen that Al and Zr exist on the surface. In addition, in the cathode active material of Comparative Example 3, the active material particles are doped with Al and Zr and there is no coating layer. Therefore, Al2p and Zr3d peaks of relatively low intensity can be seen. On the other hand, in Example 3, Al and Zr are coated on the particle surface and thus the intensity is relatively high, indicating that a coating layer is formed.

### [Experimental Example 5]—NanoSIMS Analysis

In order to confirm areas with a depth of 500 nm from the surface, nanoSIMS analysis was performed on the particle distribution of the surface of the one-body particle of Example 3, and the results are shown in FIG. 7.

From the cross-sectional EDS images of FIGS. 3 to 5 showing the results of Experimental Example 3, the boundary between the coating layer and the particles was at a depth of about 100 nm. Based on this, the intensities at a depth of less than 100 nm are values of the external coating layer of the particles, and the values at a depth of greater than 100 nm are values of the internal coating layer of the particles. In addition, from the graph in FIG. 7, it can be seen that the concentration of Al increases from the outer part of the particle to the inner part of the particle, and Zr is present at a high concentration in the outer part of the particle, and the concentration of Zr decreases toward the inner part of the particle.

In addition, the intensity in FIG. 7 was normalized and expressed, and the resulting values are shown in Tables 2 and 3 below.

TABLE 2

| Depth | 50 nm | 150 nm | 500 nm |
|---|---|---|---|
| Al intensity | (16 + 0) | (78 + 20) | (0 + 20) |
| Zr intensity | (53 + 0) | (13 + 13) | (0 + 13) |

*(Intensity due to coating + Intensity due to doping)

TABLE 3

| | Total of | External (external | Internal (internal |
|---|---|---|---|
| | internal and | coating layer/total of | coating layer/total of |
| | external | internal and external | internal and external |
| | coating layers | coating layers) | coating layers) |
| Al intensity/ | 94 (16 + 78) | 16 (17.0) | 78 (83.0) |
| (%) | | | |
| Zr intensity/ | 66 (53 + 13) | 53 (80.3) | 13 (19.7) |
| (%) | | | |

The concentration due to doping in deeper areas of the particle is maintained at a constant low value. In order to measure the concentration ratio by coating, when arbitrarily setting a baseline depth to 50 nm in the range from about 0 to 100 nm for the external coating layer and setting a baseline depth to 150 nm in the range from about 100 to 250 nm for the internal coating layer, as shown from Table 2, the Al and Zr intensities of the external coating layer are 16 and 53, respectively, and the Al and Zr intensities of the internal coating layer are 78 and 13, respectively.

In addition, as shown in Table 3 above, when the total of Al and Zr in the external coating layer and the internal coating layer is considered 100%, about 17% of Al is present at the external coating layer and about 83% of Al is present at the internal coating layer. Under the same conditions, about 80% of Zr is present at the external coating layer and about 20% of Zr is present at the internal coating layer. At this time, the depths of the arbitrarily designated external coating layer and internal coating layer may vary depending on the location of the outside of the particle.

Although preferred embodiments of the present invention have been disclosed for illustrative purposes, those skilled in the art will appreciate that various modifications, additions, and substitutions are possible without departing from the scope and spirit of the invention as disclosed in the accompanying claims.

1. A one-body particle comprising:
a core present as a non-aggregated primary particle and a coating layer formed on at least a part of the core,
wherein the coating layer is a multilayer coating layer containing at least one of a +3 or +4 element.

2. The one-body particle according to claim 1, wherein the coating layer comprises:
an internal coating layer containing at least one of Ni, Co, or Mn, and at least one of Zr, Ti, Al, W, B, P, Mg, Cr, V, or Y, and formed in an inward direction from a core surface; and
an external coating layer containing at least one of Zr, Ti, Al, W, B, P, Mg, Cr, V, or Y, and formed in an outward direction from the core surface.

3. The one-body particle according to claim 1, wherein the core comprises a composition of Formula 1 below:
LiₐNi_{b}Co_{c}Mn_{d}DₑOₓ (1)
wherein a, b, c, d, e and x satisfy 0.95≤a≤1.1, 0<b≤1, 0≤c<1, 0≤d<1, 0≤e≤0.05, and 0<x≤4, respectively; and
D includes at least one of Ti, Zr, Al, P, Si, B, W, Mg, Sn, or Y.

4. The one-body particle according to claim 1, wherein the internal coating layer comprises a composition of Formula 2 below and the external coating layer comprises a composition of Formula 3 below:
Li_{f}Ni_{g}CoₕMnᵢM1ⱼM2ₖO_{y} (2)
wherein f, g, h, i, j, k and y satisfy 0.95≤f≤1.1, 0≤g<1, 0<h<1, 0≤i<1, 0<j<1, 0<k<1, and 0<y≤8, respectively; and
M1 and M2 independently include at least one of Zr, Ti, Al, W, B, P, Mn, Ni, Mg, Cr, V, or Y, and are different from each other, and
LiₗM3ₘM4ₙO_{z} (3)
wherein l, m, n and z satisfy 0≤l≤1.1, 0<m<1, 0<n<1, and 0<z≤8, respectively; and
M3 and M4 independently include at least one of Zr, Ti, Al, W, B, P, Mn, Ni, Mg, Cr, V, or Y, and are different from each other.

5. The one-body particle according to claim 1, wherein the internal coating layer comprises a composition of Formula 2 below and the external coating layer comprises a composition of Formula 3 below:
Li_{f}Ni_{g}CoₕMnᵢM1ⱼM2ₖO_{y} (2)
wherein
f, g, h, i, j, k and y satisfy 0.95≤f≤1.1, 0≤g<1, 0<h<1, 0≤i<1, 0<j<1, 0<k<1, and 0<y≤8, respectively;
M1 is Al; and
M2 includes at least one of Zr or Ti, and
LiₗM3ₘM4ₙO_{z} (3)
wherein
l, m, n and z satisfy 0≤l≤1.1, 0<m<1, 0<n<1, and 0<z≤8, respectively;
M3 is Al; and
M4 includes at least one of Zr or Ti.

6. The one-body particle according to claim 4, wherein 30%<M1<100% and 0%<M3<70% based on a total of M1 and M3 of 100% are satisfied, and
0%<M2<30% and 70%<M4<100% based on a total of M2 and M4 of 100% are satisfied.

7. The one-body particle according to claim 4, wherein 70%≤M1≤90% and 10%≤M3≤30% based on a total of M1 and M3 of 100% are satisfied, and
10%≤M2≤30% and 70%≤M4≤90% based on a total of M2 and M4 of 100% are satisfied.

8. The one-body particle according to claim 4, wherein the internal coating layer and the external coating layer simultaneously comprise at least one element, and the element has a concentration gradient.

9. The one-body particle according to claim 1, wherein the internal coating layer comprises a composition of Formula 2 below and the external coating layer comprises compositions of Formula 3 and Formula 4 below:
Li_{f}Ni_{g}CoₕMnᵢM1ⱼM2ₖO_{y} (2)
wherein
f, g, h, i, j, k and y satisfy 0.95≤f≤1.1, 0≤g<1, 0<h<1, 0<i<1, 0<j<1, 0<k<1, and 0<y≤8, respectively; and
M1 and M2 independently include at least one of Zr, Ti, Al, W, B, P, Mn, Ni, Mg, Cr, V, or Y and are different from each other,
LiₗM3ₘM4ₙM5ₒO_{z} (3)
wherein
l, m, n, o and z satisfy 0≤l≤1.1, 0<m<1, 0<n<1, 0<o<1, and 0<z≤8, respectively; and
M3, M4 and M5 independently include at least one of Zr, Ti, Al, W, B, P, Mn, Ni, Mg, Cr, V, or Y and are different from each other, and
LiₚM6₉M7ᵣOᵥ (4)
wherein
p, q, r and v satisfy 0≤p≤1.1, 0<q<1, 0<r<1, and 0<v≤8, respectively; and
M6 and M7 independently include at least one of Zr, Ti, Al, W, B, P, Mn, Ni, Mg, Cr, V, or Y, and are different from each other.

10. The one-body particle according to claim 1, wherein the internal coating layer comprises a composition of Formula 2 below and the external coating layer comprises compositions of Formula 3 and 4 below:
Li_{f}Ni_{g}CoₕMnᵢM1ⱼM2ₖO_{y} (2)
wherein
f, g, h, i, j, k and y satisfy 0.95≤f≤1.1, 0≤g<1, 0<h<1, 0≤i<1, 0<j<1, 0<k<1, and 0<y≤8, respectively;
M1 is Al; and
M2 includes at least one of Zr or Ti,
LiₗM3ₘM4ₙM5ₒO_{z} (3)
wherein
l, m, n, o and z satisfy 0≤l≤1.1, 0<m<1, 0<n<1, 0<o<1, and 0<z≤8, respectively;
M3 is Al;
M4 includes at least one of Zr or Ti; and
M5 is B,
LiₚM6_{q}M7ᵣOᵥ (4)
wherein
p, q, r and v satisfy 0≤p≤1.1, 0<q<1, 0<r<1, and 0<v<8, respectively;
M6 includes at least one of Zr or Ti; and
M7 is B.

11. The one-body particle according to claim 10, wherein 30%<M1<100% and 0%<M3<70% based on a total of M1 and M3 of 100% are satisfied,
0%<M2<30%, 70%<M4<100% and 0%<M6<30% based on a total of M2, M4 and M6 of 100% are satisfied, and
0%<M5<40% and 60%<M7<100% based on a total of M5 and M7 of 100% are satisfied.

12. The one-body particle according to claim 4, wherein at least one of the internal coating layer or the external coating layer is in the form of an island.

13. The one-body particle according to claim 1, wherein the coating layer comprises no cobalt (Co).

14. An active material for secondary batteries comprising an aggregate including a plurality of one-body particles, or a mixture of non-aggregated one-body particles and the aggregate,
the active material comprising a coating layer formed in at least one area of grain boundaries where surfaces of the one-body particles constituting the aggregate come into contact with each other, pores or gaps between the one-body particles, and the surfaces of the one-body particles,
wherein the coating layer is formed as a multilayer coating layer containing at least one of a +3 or +4 element.

15. The active material according to claim 14, wherein the coating layer comprises:
an internal coating layer containing at least one of Ni, Co, or Mn, and at least one of Zr, Ti, Al, W, B, P, Mg, Cr, V, or Y, and formed in an inward direction from a core surface; and
an external coating layer containing at least one of Zr, Ti, Al, W, B, P, Mg, Cr, V, or Y, and formed in an outward direction from the core surface.

16. The one-body particle according to claim 5, wherein 30%<M1<100% and 0%<M3<70% based on a total of M1 and M3 of 100% are satisfied, and
0%<M2<30% and 70%<M4<100% based on a total of M2 and M4 of 100% are satisfied.

17. The one-body particle according to claim 5, wherein 70%≤M1≤90% and 10%≤M3≤30% based on a total of M1 and M3 of 100% are satisfied, and
10%<M2≤30% and 70%≤M4≤90% based on a total of M2 and M4 of 100% are satisfied.

18. The one-body particle according to claim 5, wherein the internal coating layer and the external coating layer simultaneously comprise at least one element, and the element has a concentration gradient.

19. The one-body particle according to claim 5, wherein at least one of the internal coating layer or the external coating layer is in the form of an island.

20. The one-body particle according to claim 9, wherein at least one of the internal coating layer or the external coating layer is in the form of an island.
